(19) United States
(12) Patent Application Publication
(10) Pub. No.: US 2011/0214071 A1
(43) Pub. Date: Sep. 1, 2011

(54) INFORMATION CHANNELS IN MMOGS

(75) Inventors: MICHAEL ZYDA, Carmel, CA (US); BJARNI ARNASON, Los Angeles, CA (US); BALKI RANGANATHAN, Chennai (IN); MARC SPRARAGEN, Los Angeles, CA (US)

(73) Assignee: UNIVERSITY OF SOUTHERN CALIFORNIA, Los Angeles, CA (US)

(21) Appl. No.: 12/891,556

(22) Filed: Sep. 27, 2010

Related U.S. Application Data
(60) Provisional application No. 61/308,705, filed on Feb. 26, 2010.

(51) Int. Cl. G06F 3/01; G06Q 40/00

(52) U.S. Cl. 715/753; 705/35; 705/37

(57) ABSTRACT

Real world news may be received in real time. A real world occurrence may be extracted from the real world news. An attribute of a virtual world may be modified in response to the extracted real world occurrence.

A message may be selected based on an attribute relating to a participant in the virtual world. The selected message may be displayed to the participant on a display in the virtual world, along with other messages to other participants selected in the same way. Different participants may therefore see different selected messages on the same display.

A display within the virtual world may display at least a portion of real world news in real time.

A communication channel may allow only a subset of participants to send messages. The messages may be displayed to other participants in the virtual world.

### CROSS-REFERENCE TO RELATED APPLICATIONS

This application is based upon and claims priority to U.S. provisional patent application 61/308,705, entitled “INTEGRATED NEWSFEEDS,” filed Feb. 26, 2010, attorney docket number 028080-0553. The entire content of this application is incorporated herein by reference.

### STATEMENT REGARDING FEDERALLY SPONSORED RESEARCH

This invention was made with Government support under Contract No. NPS-N00244-08-1-0038, awarded by the United States Naval Postgraduate School and under Contract No. ONR-N00014-09-1-0155, awarded by the Office of Naval Research. The Government has certain rights in the invention.

### BACKGROUND

1. Technical Field

This disclosure relates to multi-participant virtual world systems, including Massively Multi-Player Online Games (MMOGs).

2. Description of Related Art

Multi-participant virtual worlds, such as Massively Multi-Player Online Games (MMOGs), may provide entertainment, education, information, and/or other forms of communication and/or activities. These virtual worlds, however, are often completely independent from the real world. This independence can reduce their effectiveness, particularly when the virtual world is intended to simulate social and organizational environments.

### SUMMARY

A multi-participant virtual world system may include a virtual world engine, a real world news feed interface, a real world news analysis system, and a virtual world modification system. The virtual world engine may be configured to generate a virtual world in which multiple participants may participate. The real world news feed interface may be configured to receive real world news in real time. The real world news analysis system may be configured to extract a real world occurrence from the real world news based on an interpretation of the real world news. The virtual world modification system may be configured to modify an attribute of the virtual world in response to the extracted real world occurrence.

The real world occurrence may be a change in the real world weather. The virtual world modification system may be configured to modify the weather in the virtual world in a manner that tracks the change in the real world weather.

The virtual world may include a virtual character. The virtual character may be a player character or a non-player character. The modification system may be configured to modify an attribute of the virtual character in response to the real world occurrence. The attribute may be an emotion of the virtual character, clothing worn by or an accessory associated with the virtual character, an action taken by the virtual character, and/or an option which may be selected relating to the virtual character.

The virtual world may include a virtual world asset. The real world occurrence may be a change in the value of a comparable real world asset. The virtual world modification system may be configured to modify the value of the virtual world asset in response to the change in the value of the real world asset.

The virtual world asset may be a virtual world commodity. The real world asset may be a comparable real world commodity.

The virtual world asset may be a virtual world currency. The real world asset may be a real world currency. The virtual world modification system may be configured to modify an exchange rate between the virtual world currency and the real world currency in response to the change in the value of the real world currency.

The multi-participant virtual world system may include a participant notification system configured to notify the participants of the real world occurrence.

The multi-participant virtual world system may include a message selection system configured to select a message to be communicated to each of the participants from a set of different messages based on an attribute relating to the participant. The multi-participant virtual world system may include a virtual world display configured to display the selected message to the participant at a location within the virtual world. Different participants may therefore see different messages on the same virtual world display.

The selected message may be a news item. The set of different messages may be a set of different news items.

The selected message may be an advertisement. The set of different messages may be a set of different advertisements.

The selected message may be an announcement relating to the virtual world. The set of different messages may be a set of different announcements relating to the virtual world.

A virtual world display may be at a location within the virtual world and may be configured to display at least a portion of the real world news in real time. The real world news may be a weather report and/or the price of an asset, such as a stock, a commodity, or a currency exchange rate.

The real world news feed interface may be configured to receive a plurality of channels of real world news in real time. The virtual world display may be configured to display at least a portion of a selected one of the channels of the real world news in real time.

The real world news feed interface may be configured to receive the real world news in real time from the Internet.

The multi-participant virtual world system may include a virtual world messaging system configured to allow only a subset of the participants to send messages. The multi-participant virtual world system may include a display configured to display the messages to participants in addition to those that are sending the messages.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings illustrate illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 illustrates an example of a multi-participant virtual world system.

FIGS. 2A and 2B illustrate an example of how the multi-participant virtual world system illustrated in FIG. 1 may cause real world news to affect attributes in a virtual world, namely the weather and an accessory in this example.

FIG. 3 illustrates another example of how the multi-participant virtual world system illustrated in FIG. 1 may cause real world news to affect an attribute of a virtual world, namely an exchange rate between a real world currency and a virtual world currency in this example.

FIG. 4 illustrates an example of how the multi-participant virtual world system illustrated in FIG. 1 may cause different participants to see different messages on the same virtual world display, namely a different advertisement in this example.

FIG. 5 illustrates an example of how the multi-participant virtual world system illustrated in FIG. 1 may cause real world news to be displayed on a virtual world display in real time.

FIG. 6 illustrates an example of how the multi-participant virtual world system illustrated in FIG. 1 may cause messages between only a subset of participants in a virtual world to be displayed to participants in addition to those sending the messages.

### DETAILED DESCRIPTION OF ILLUSTRATIVE EMBODIMENTS

Illustrative embodiments are now described. Other embodiments may be used in addition or instead. Details which may be apparent or unnecessary may be omitted to save space or for a more effective presentation. Some embodiments may be practiced with additional components or steps and/or without all of the components or steps which are described.

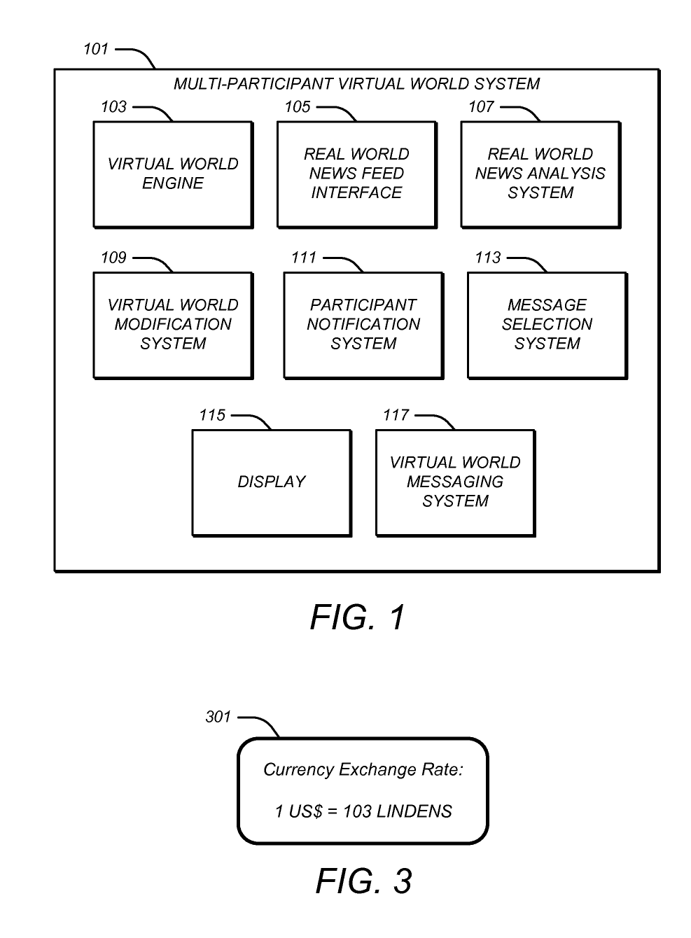

FIG. 1 illustrates an example of a multi-participant virtual world system 101. The system may be configured to generate and manage two and/or three dimensional imagery of a virtual world. The virtual world may exist for any purpose, such as for entertainment, education, social interaction, or e-commerce. The virtual world may be a game, such as a Massively Multi-Player Online Game (MMOG).

The multi-participant virtual world system 101 may include a variety of components. For example, the multi-participant virtual world system 101 may include a virtual world engine 103, a real world news feed interface 105, a real world news analysis system 107, a virtual world modification system 109, a participant notification system 111, a message selection system 113, a display 115, and a virtual world messaging system 117.

Each of these components may be implemented by computer software running on computer hardware. The computer software may include one or more algorithms configured to perform each of the functions which these components are described herein as performing. The computer hardware may include one or more processors, memories, and other hardware components configured to run the computer software, so as to enable the computer software to perform these functions. The computer hardware may include interfaces which enable communications to and from participants in the virtual world. These communications may contain virtual images, messages, and other information.

The virtual world engine 103 may be configured to generate a virtual world in which the multiple participants may participate. For example, the virtual world engine 103 may generate imagery of buildings, displays, vehicles, land, sky, trees, plants, etc. The virtual world engine 103 may generate sounds, such as speech, environmental sounds, etc. The virtual world engine 103 may generate changing images of characters in the virtual world, including characters controlled by the participants and/or automated characters not controlled by any participant. Examples of such virtual world engines include the engines which currently generate and manage the imagery, sounds, and communications in Second Life, World of Warcraft, and EVE Online.

The real world news feed interface 105 may be configured to receive real world news in real time. The real world news feed interface 105 may be configured to receive this news over the internet. For example, the real world news feed interface 105 may include an XML file which contains URL's of news sites and a list of keywords indicative of news which is of interest at these sites. The real world news feed interface 105 may be configured to query these news sites for news containing one or more of these keywords and to download .rss files containing this.

The real world news feed interface 105 may be triggered to seek this news on any basis. For example, the real world news feed interface 105 may be configured to seek news updates on a periodic basis and/or in response to a user request. The frequency at which the real world news feed interface 105 seeks updates may be based upon the content of news which has previously been received. The real world news feed interface 105 may be triggered by externally, such as by important news announcements delivered to the real world news feed interface 105.

The real world news analysis system 107 may be configured to extract a real world occurrence from the real world news based on an interpretation of the real world news which the real world news feed interface 105 receives. In order to accomplish this, the real world news analysis system 107 may utilize natural Language Processing, Knowledge/Information Dissemination Algorithms, and/or any other technology that can interpret the real world news and extract a real world occurrence from it. For example, a weather report may indicate that it has started to rain at a particular location. The real world news analysis system 107 may be configured to extract key words from this report that it is now raining at that particular location.

The virtual world modification system 109 may be configured to modify an attribute of the virtual world in response to the extracted real world occurrence. For example, the real world occurrence may be a change in the real world weather. The virtual world modification system 109 may be configured to modify the weather in the virtual world in a manner that tracks the change in the real world weather.

Different weather conditions in the real world may trigger different graphic renderings in the virtual world. For example, different sky boxes, environment maps, lighting, and particle effects may be used to simulate different weather conditions. A database may be maintained containing regional mappings of real-world weather conditions. This database may be referenced, for example, when a player character visits different virtual regions that simulate these real-world regions.

The virtual world modification system 109 may be configured to modify an attribute of a virtual character in the virtual world in response to the real-world occurrence. The virtual character may be a player character or a non-player character.

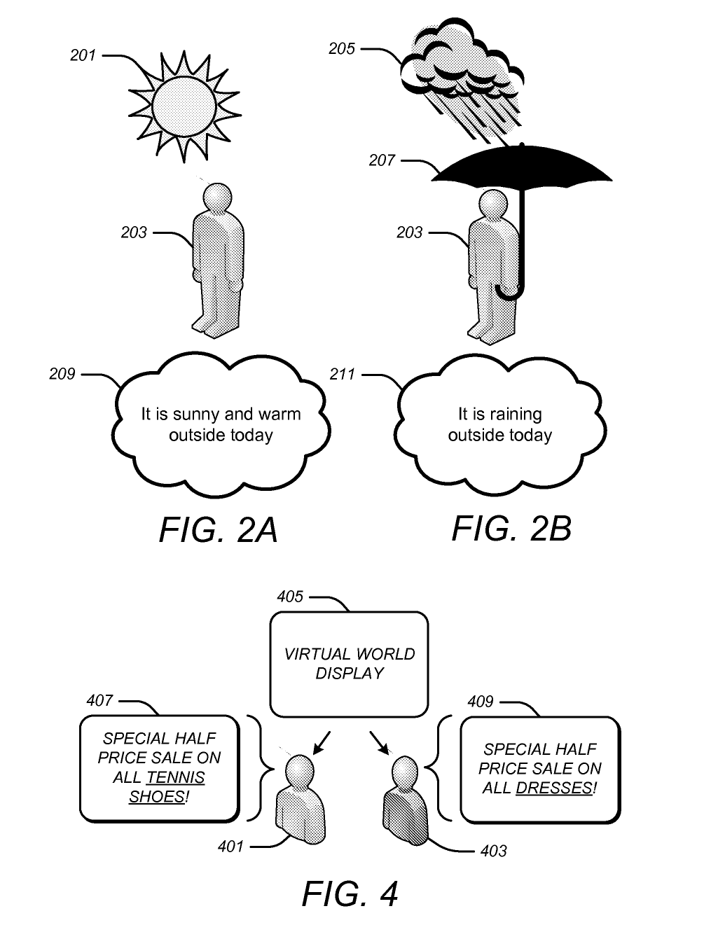

FIGS. 2A and 2B illustrate an example of how the multi-participant virtual world system 101 illustrated in FIG. 1 may cause real world news to affect attributes in a virtual world, namely the weather and an accessory in this example. FIGS. 2A and 2B may illustrate an environment which simulates an area within the real world. That area may currently be experiencing sunshine. Real time news of that sunshine may be received by the real world news feed interface 105. The real world news analysis system 107 may interpret that real world news and extract from it the real world occurrence that the sun is shining. The virtual world modification system 109 may then cause the sun to be shining in the virtual world, as evidenced by a sun 201 in FIG. 2A. The sun 201 may shine on a virtual character 203 in FIG. 2A. The virtual character 203 may be a player character or a non-player character.

The sun may subsequently disappear and rain may begin to fall in this area of the real world. Real time news of this change in the weather may be received by the real world news feed interface 105. The real world news analysis system 107 may then extract the real world occurrence that it is now raining based on an interpretation of this real world news. In turn, the virtual world modification system 109 may modify an attribute of the virtual world in response to this real world occurrence, such as by removing the sun 201 and replacing it with clouds and rain 205, as reflected in FIG. 2B.

The virtual world modification system 109 may in addition or instead be configured to modify an attribute of a virtual character in the real world in response to the real world occurrence. The virtual character may be a player character or a non-player character. The attribute may be an emotion of the virtual character, clothing worn by the virtual character, an accessory associated with the virtual character, and/or action taken by the virtual character. As illustrated in FIG. 2B, for example, the virtual world modification system 109 may cause an umbrella 207 to be carried by the virtual character 203 in response to the real world occurrence that it is now raining. The virtual world modification system 109 may in addition or instead cause the virtual character 203 to run for cover and/or to display an expression of surprise, particularly if the rain in the real world came on suddenly.

The virtual world modification system 109 may be configured to in addition or instead change one or more options which a user may select in connection with a virtual character in response to a real world occurrence. The virtual character may be a player character or a non-player character. The importance of and/or the reputation of a virtual character may also be changed in response to a real world occurrence.

The participant notification system 111 may be configured to notify participants in the virtual world of the real world occurrence, particularly when the real world occurrence represents a significant and important change. In FIG. 2A, for example, the participant notification system 111 may provide a message 209 to the virtual world participants that it is currently sunny and warm outside. When it begins to rain in the real world, on the other hand, the participant notification system 111 may be configured to provide an update notice 211 to participants in the virtual world, such as to advise them that it is raining outside today, as illustrated in FIG. 2B. These notifications may be provided on the display 115. The display 115 may be a display within the virtual world, such as a two-dimensional message board or a message cube. The display 115 may in addition or instead be a scrolling line of text on a screen and/or a small scrollable window. Important real-world headlines may be displayed on the display 115.

The virtual world may include one or more virtual world assets. The real world occurrence may be a change in the value of comparable real world asset. The virtual world modification system 109 may be configured to modify the value of the virtual world asset in response to the change in the value of the real world asset. The virtual world modification system 109 may maintain a database of real-world assets and update this database when there are updates to the corresponding virtual world asset. This may be done in accordance with a periodic or different schedule.

The virtual world asset may be a virtual world commodity. The real world asset may be a comparable real world commodity.

FIG. 3 illustrates another example of how the multi-participant virtual world system illustrated in FIG. 1 may cause real world news to affect an attribute of a virtual world, namely an exchange rate between a real world currency and a virtual world currency in this example. As illustrated in FIG. 3, the display 301, which may be any of the types of displays discussed above in connection with the display 115, may display a currency exchange rate between the real world currency (the US dollar in this example), and a virtual world currency (Lindens in this example). This may be updated by the virtual world modification system 109 based on updates received by the real world news feed interface 105 and interpreted by the real world news analysis system 107. The updates may be made whenever this exchange rate is sought in the virtual world,

The message selection system 113 may be configured to select a message to be communicated to each of the participants from a set of different messages, based on one or more attributes relating to the participant. The display 115 may be configured to display the selected message to each of the participants at a location within the virtual world. As a consequence, different participants with different attributes may see different messages on the same virtual world display.

The attribute(s) relating to the participant which are used by the message selection system 113 to select the message to be communicated to the participant may be of any type. For example, the attribute(s) which is (are) examined may include the participant's sex, age, buying history, current geographic location, clothing, prior activity, interests (expressed or tracked), virtual world affiliations (tribe, guild), and/or preferred language.

The set of different messages may be a set of different news items, advertisements, and/or announcements relating to the virtual world. The message selection system 113 may be configured to select one of these news items, advertisements, and/or announcements to display to a particular participant, again based on one or more attributes relating to that participant.

FIG. 4 illustrates an example of how the multi-participant virtual world system illustrated in FIG. 1 may cause different participants to see different messages on the same virtual world display, namely a different advertisement in this example. As illustrated in FIG. 4, two participants 401 and 403 may view the same virtual world display 405, but see different messages, namely a message relating to a tennis shoe sale 407 by the participant 401 and a message relating to a dress sale 409 by the participant 403.

The display 115 may be configured to display all or portions of the real world news received by the real world news feed interface 105 in real time, without analysis by the real world news analysis system 107. The display 115 may be within the virtual world and may be a bulletin board, interactive cube, or any other type of display. The real world news may be of any type. For example, it may be a real world weather report or a report about the real world price of an asset, such as a stock, commodity, or currency exchange rate.

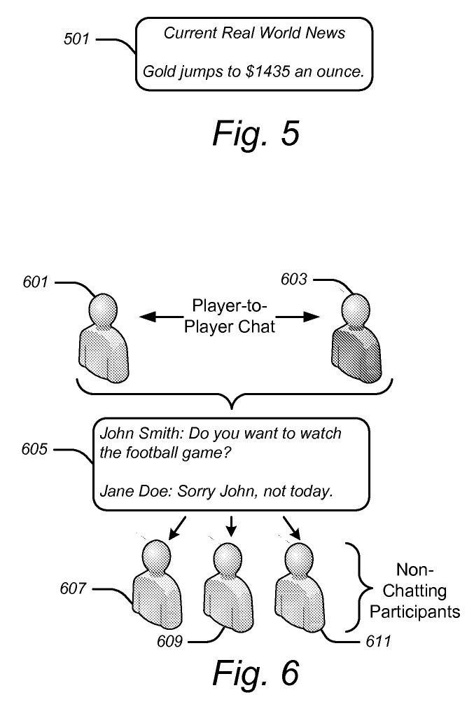

FIG. 5 illustrates an example of how the multi-participant virtual world system illustrated in FIG. 1 may cause real world news to be displayed on a virtual world display in real time. As illustrated in FIG. 5, a display 501 within a virtual world may be configured to display current real world news, such as a change in the price of gold.

The real world news feed interface 105 may be configured to receive a plurality of channels of real world news in real time. The display 115 may be configured to display at least a portion of a selected one of the channels of the real world news in real time within the virtual world. The selection may be made by a participant or by other means.

The virtual world messaging system 117 may be configured to allow only a subset of the participants in the virtual world to send message on a message channel. For example, the messaging system 113 may be configured to allow only two participants in the virtual world to send messages on the message channel. The display 115 may nevertheless be configured to display the messages sent by the subset of participants to other participants in the virtual world. The display 115 may be configured to present this display within the virtual world or outside of it. The net result of this configuration may be that participants in the virtual world who are not able to send messages on a message channel may nevertheless be permitted to see them.

FIG. 6 illustrates an example of how the multi-participant virtual world system illustrated in FIG. 1 may cause messages between only a subset of participants in a virtual world to be displayed to participants in addition to those sending the messages. As illustrated in FIG. 6, participants 601 and 603 may be able to exchange message between themselves on a messaging channel, such as the messages illustrated in a display 605. Notwithstanding, the display 605 may be viewable by participants in the virtual world, in addition to those sending the messages, such as participants 607, 609, and 611.

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged and/or ordered differently.

For example, a human participant might read a newsfeed and broadcast his character's interpretation of it to a region of a virtual world, affecting software-controlled inhabitants of that region.

Unless otherwise stated, all measurements, values, ratings, positions, magnitudes, sizes, and other specifications which are set forth in this specification, including in the claims which follow, are approximate, not exact. They are intended to have a reasonable range which is consistent with the functions to which they relate and with what is customary in the art to which they pertain.

All articles, patents, patent applications, and other publications which have been cited in this disclosure are incorporated herein by reference.

The phrase “means for” when used in a claim is intended to and should be interpreted to embrace the corresponding structures and materials which have been described and their equivalents. Similarly, the phrase “step for” when used in a claim is intended to and should be interpreted to embrace the corresponding acts which have been described and their equivalents. The absence of these phrases in a claim mean that the claim is not intended to and should not be interpreted to be limited to any of the corresponding structures, materials, or acts or to their equivalents.

None of the claims are intended to embrace non-statutory subject matter, such as an abstract idea, law of nature or natural phenomena; obvious subject matter; nor subject matter lacking novelty, nor should they be interpreted in such a way. Any unintended embracement of such subject matter is hereby disclaimed.

Except as stated immediately above, nothing which has been stated or illustrated is intended or should be interpreted to cause a dedication of any component, step, feature, object, benefit, advantage, or equivalent to the public, regardless of whether it is recited in the claims.

The scope of protection is limited solely by the claims which now follow. That scope is intended and should be interpreted to be as broad as is consistent with the ordinary meaning of the language which is used in the claims when interpreted in light of this specification and the prosecution history which follows and to encompass all structural and functional equivalents.

The invention claimed is:

1. A multi-participant virtual world system comprising:
a virtual world engine configured to generate a virtual world in which multiple participants may participate;
a real world news feed interface configured to receive real world news in real time;
a real world news analysis system configured to extract a real world occurrence from the real world news based on an interpretation of the real world news; and
a virtual world modification system configured to modify an attribute of the virtual world in response to the extracted real world occurrence.

2. The multi-participant virtual world system of claim 1 wherein the real world occurrence is a change in the real world weather and wherein the virtual world modification system is configured to modify the weather in the virtual world in a manner that tracks the change in the real world weather.

3. The multi-participant virtual world system of claim 1 wherein the virtual world includes a virtual character and wherein the modification system is configured to modify an attribute of the virtual character in response to the real world occurrence.

4. The multi-participant virtual world system of claim 3 wherein the attribute is an emotion of the virtual character.

5. The multi-participant virtual world system of claim 3 wherein the attribute is clothing worn by or an accessory associated with the virtual character.

6. The multi-participant virtual world system of claim 3 wherein the attribute is an action taken by the virtual character.

7. The multi-participant virtual world system of claim 3 wherein the attribute is an option which may be selected relating to the virtual character.

8. The multi-participant virtual world system of claim 1 wherein the virtual world includes a virtual world asset, the real world occurrence is a change in the value of a comparable real world asset, and the virtual world modification system is configured to modify the value of the virtual world asset in response to the change in the value of the real world asset.

9. The multi-participant virtual world system of claim 8 wherein the virtual world asset is a virtual world commodity and the real world asset is a comparable real world commodity.

10. The multi-participant virtual world system of claim 8 wherein the virtual world asset is a virtual world currency, the real world asset is a real world currency, and the virtual world modification system is configured to modify an exchange rate between the virtual world currency and the real world currency in response to the change in the value of the real world currency.

11. The multi-participant virtual world system of claim 1 further comprising a participant notification system configured to notify the participants of the real world occurrence.

12. A multi-participant virtual world system comprising:
a virtual world engine configured to generate a virtual world in which multiple participants may participate;
a message selection system configured to select a message to be communicated to each of the participants from a set of different messages based on an attribute relating to the participant; and
a virtual world display configured to display the selected message to the participant at a location within the virtual world,
whereby different participants see different messages on the same virtual world display.

13. The multi-participant virtual world system of claim 12 wherein the selected message is a news item and the set of different messages is a set of different news items.

14. The multi-participant virtual world system of claim 12 wherein the selected message is an advertisement and the set of different messages is a set of different advertisements.

15. The multi-participant virtual world system of claim 12 wherein the selected message is an announcement relating to the virtual world and the set of different messages is a set of different announcements relating to the virtual world.

16. A multi-participant virtual world system comprising:
a virtual world engine configured to generate a virtual world in which multiple participants may participate;
a real world news feed interface configured to receive real world news in real time; and
a virtual world display at a location within the virtual world configured to display at least a portion of the real world news in real time.

17. The multi-participant virtual world system of claim 16 wherein the real world news is a weather report.

18. The multi-participant virtual world system of claim 16 wherein the real world news is the price of an asset, such as a stock, a commodity, or a currency exchange rate.

19. The multi-participant virtual world system of claim 16 wherein
the real world news feed interface is configured to receive a plurality of channels of real world news in real time; and
the virtual world display is configured to display at least a portion of a selected one of the channels of the real world news in real time.

20. The multi-participant virtual world system of claim 16 wherein the real world news feed interface is configured to receive the real world news in real time from the Internet.

21. A multi-participant virtual world system comprising:
a virtual world engine configured to generate a virtual world in which multiple participants may participate;
a virtual world messaging system configured to allow only a subset of the participants to send messages on a communication channel; and
a display configured to display the messages to participants in addition to those that sending the messages.
